(19) United States
(12) Patent Application Publication
(10) Pub. No.: US 2017/0225191 A1
(43) Pub. Date: Aug. 10, 2017

(54) ROTARY DISPENSER FOR MULTIPLE CARTRIDGE

(71) Applicant: MEDMIX SYSTEMS AG, Rotkreuz (CH)

(72) Inventors: Manuel FURRER, Beinwil/Freiamt (CH); Beat MATHYS, Muri (CH)

(73) Assignee: MEDMIX SYSTEMS AG, Rotkreuz (CH)

(21) Appl. No.: 15/501,210

(22) PCT Filed: Aug. 19, 2014
(86) PCT No.: PCT/EP2014/067674

§ 371 Date: Feb. 2, 2017

(51) Int. Cl. B05C 17/005; B05C 17/01

(52) U.S. Cl. CPC B05C 17/00553; B05C 17/01

(57) ABSTRACT

A discharge device that serves the purpose of discharging at least two components from a multiple cartridge. The discharge device has a housing, a threaded rod and an advancing element with an internal thread. The threaded rod engages in the internal thread of the advancing element such that the advancing element can be pushed forward in a distal direction by turning the threaded rod in relation to the housing. In the region of its distal end, the threaded rod has a taper. Formed on the housing, in the region of its distal end, is a holding element. The holding element has a laterally open clearance, and the threaded rod is pushed with its taper laterally into the clearance of the holding element such that the holding element fixes the threaded rod axially in the housing in the distal direction and in a proximal direction opposite thereto.

### TECHNICAL FIELD

The present invention relates to a discharge device for a multiple cartridge or for at least two syringes in order to discharge at least two components from the multiple cartridge or from the syringes. Such a discharge device is also designated below as a dispenser.

### PRIOR ART

In various technical areas discharge devices are used to discharge a flowable (fluid) product, thus for example, in the fields of medical or dental technology. In this case, storing two or more components of such a product in separate syringes or in separate chambers of a multiple cartridge and not mixing them to form the finished product until they are discharged is known, as the finished product is not suitable for storage in the mixed state. Examples are medical and non-medical two-component adhesives, bone cement, etc. Discharge devices which are suitable for discharging and mixing two separately stored components are disclosed, for example, in the documents WO 2007/041266, WO 2009/086644, WO 2008/009143 or WO 2009/086650.

DE 10 2010 045935 discloses a container which includes a container body, a piston that is movable in the longitudinal direction and a cover with an outlet opening. A threaded spindle, which is connected to the cover and functions as a drive shaft extends through the container. The threaded spindle has an external thread which interacts with an internal thread of the piston. The piston is mounted so as to be non-rotatable in the container body. When the spindle is rotated, the piston is moved in the direction toward the cover, as a result of which the piston drives the contents of the container out through the outlet opening. In the case of said device, however, the product stored in the container is in contact with the threaded spindle. The container is additionally only suitable for discharging one single component or one single finished product. When several components are to be discharged, several of these kinds of containers are arranged side by side and are driven separately.

DE 20 2006 011 103 discloses a dispenser for simultaneously discharging two products, which dispenser has a housing with two cylinders formed therein in which the products are situated. One piston is displaceably guided in each of the cylinders. To displace the piston, a piston holder with an internal thread is mounted on the piston and it meshes with an external thread of a threaded spindle. The threaded spindle is provided with a thumb wheel which can be rotated with reference to the housing, and as a result, displaces the piston holder, consequently also the pistons, in the longitudinal direction of the rotary spindle. A resultant increase in pressure in the cylinders opens valves, as a result of which the products are discharged. At its distal end, the threaded spindle comprises a ball-shaped end region which is inserted axially into a corresponding guide bush and is fixed there axially in a latching manner. In particular, where there is high counter pressure, there is the risk here of the threaded spindle being pressed out of the guide bush in the proximal direction, as a result of which the dispenser would be non-functional. In addition, said dispenser is only suitable for single use and, in particular, is not able to be used with replacement containers.

### SUMMARY OF THE INVENTION

It is an object of the present invention to provide a discharge device which is suitable for simultaneously discharging two or more components from a multiple cartridge or from separate syringes, said device being simple in design and functioning reliably even when used at a high discharge pressure.

Said object is achieved with a discharge device for discharging components from a multiple cartridge or from two or more syringes, as specified in claim 1. Further embodiments are provided in the dependent claims.

Provided, therefore, is a discharge device (a dispenser) for a multiple cartridge or for at least two syringes in order to discharge at least two components from the multiple cartridge or from the syringes. The discharge device comprises a housing with a proximal end and a distal end, a threaded rod with a proximal end and a distal end, wherein the threaded rod has an external thread and is arranged so as to be rotatable in the housing, and an advancing element with a proximal end and a distal end, wherein the advancing element has an internal thread and is arranged so as to be axially displaceable and non-rotatable in the housing. The external thread of the threaded rod engages in such a manner in the internal thread of the advancing element that, as a result of a rotation of the threaded rod relative to the housing, the advancing element is advanceable in a distal direction (insofar as it is a “rotary dispenser”). The threaded rod comprises a tapering (a region of reduced diameter or neck) in the region of its distal end. A retaining element is formed on the housing in the region of its distal end, wherein the retaining element comprises a laterally (at the side) open recess and wherein the threaded rod is inserted in such a manner laterally (at the side) by way of its tapering into the recess of the retaining element that the retaining element fixes the threaded rod axially in the housing both with reference to the distal direction and with reference to a proximal direction that is opposite thereto.

By the threaded rod being inserted laterally by way of a tapering into a laterally open recess on the retaining element, fixing the threaded rod axially with reference to two opposite directions is achieved in a very simple and elegant manner. Said type of connection is able to absorb relatively large axial forces in particular when compared to an axial latching connection. As a result, it can be ensured that the dispenser functions reliably even in the case of large amounts of counter pressure. This is important in particular when relatively tough, highly-viscous components are to be discharged. At the same time, said type of fixing means that the dispenser can be simple in design and produced and assembled a simple manner.

In conjunction with the present invention, a syringe is to be understood as a container which delimits a reservoir for a fluid component, a piston (plug) being displaceably arranged in the reservoir, and the fluid component being dischargeable out of the container through an outlet opening as a result of displacement of the piston in a distal direction.

A multiple cartridge is to be understood as a container which delimits two or more reservoirs for, in each case, one fluid component, a piston (plug) being arranged in each case so as to be displaceable in each of the reservoirs, and the respective fluid component being dischargeable out of the relevant reservoir as a result of displacement of the associated piston in a distal direction.

In a preferred embodiment, the advancing element forms a double plunger with two piston rods which are arranged in parallel and are connected proximally by means of a threaded bush, wherein the internal thread is formed in the threaded bush. The piston rods extend on both sides of the threaded rod in the distal direction such that one of the piston rods prevents the threaded rod from moving out of the recess of the retaining element.

The threaded rod can be fixed very simply at the side (laterally) on its distal end in this way. The retaining element and one of the piston rods interact here in an elegant manner in order to ensure said lateral fixing.

The retaining element can be designed as a bridge which extends between two laterally oppositely situated regions of the housing. By the retaining element being connected at two ends to the housing in the manner of a bridge, unwanted bending and torsion effects of the retaining element are avoided, and the retaining element is able to absorb greater forces.

A thickening is preferably formed on the distal end of the threaded rod, in a region located distally from the tapering. The thickening is arranged distally to the retaining element and comprises a greater diameter than the recess. The thickening can be designed in the form of an end plate, i.e. in the form of a disk. It can, however, also assume other forms, e.g. the form of a hemisphere.

In order to facilitate the actuation of the dispenser, the discharge device can comprise a rotary member which is arranged so as to be rotatable on the proximal end of the housing and is connected non-rotatably to the proximal end of the threaded rod. The rotary member is preferably configured for the purpose of being rotated by a hand of a user in relation to the housing in order, thus, to make the threaded rod rotate in relation to the housing. The rotary member can be designed, for example, in the shape of a drum for this purpose. However, it can also be in another form. For example, it can be provided with a rotary handle. The housing is preferably dimensioned accordingly in such a manner that it is easily able to be gripped and held by the other hand of the user.

In order to prevent a movement of the advancing element in the proximal direction beyond a proximal starting position, the rotary member can comprise at least one stop surface, which delimits a proximal movement of the advancing element relative to the housing, on an inside surface which is situated opposite the proximal end of the housing.

The rotary member can be designed in a drum-like manner with a lateral surface wall. In said case, it is advantageous when the proximal end of the housing comprises a guide surface which tapers in the manner of a cone in the proximal direction, and when the rotary member comprises, on the inside of its lateral surface wall, a conical counter surface which is complementary to the guide surface and is widened accordingly in the distal direction. As a result, on the one hand the placing of the rotary member onto the housing is made easier, and on the other hand, as a result of the interaction between the guide surface and the counter surface, it is ensured that the rotary member, and consequently also the threaded rod, can be guided in rotation in a defined and self-centering manner.

At least one container receiving means for fastening the multiple cartridge or the syringes on the housing is formed on the distal end of the housing. The container receiving means can be designed, in this case, in such a manner that the multiple cartridge or the syringes are insertable laterally into the container receiving means. However, it is also conceivable for the multiple cartridge or the syringes to be fastened in another manner on the housing, e.g. by a bayonet connection or by an axial latching connection, or even by the multiple cartridge or the syringes being formed integrally with the housing.

The discharge device can be supplemented by the already mentioned multiple cartridge or by at least two syringes. The multiple cartridge or the syringes then form, as a rule, at least two outlets. The advancing element is insertable into the multiple cartridge or into the syringes in order to discharge the components through the outlets out of the multiple cartridge or the syringes. In addition, the discharge device can include a mixing attachment which is mounted above the outlets in order to mix the components which emerge from the outlets.

### BRIEF DESCRIPTION OF THE DRAWINGS

Preferred embodiments of the invention are described below by way of the drawings which serve purely for explanation and are not to be seen as restricting and in which:

FIG. 1 shows a discharge device with a multiple cartridge and mixer fastened thereon;

FIG. 2 shows the discharge device of FIG. 1 with the multiple cartridge removed;

FIG. 3 shows a perspective view of the housing of the discharge device of FIG. 1;

FIG. 4 shows a perspective view of the rotary drum of the discharge device of FIG. 1;

FIG. 5 shows a perspective view of the threaded rod of the discharge device of FIG. 1;

FIG. 6 shows a perspective view of the advancing element of the discharge device of FIG. 1;

FIG. 7 shows a central longitudinal section through the discharge device of FIG. 1 in an initial state;

FIG. 8 shows a cross section through the discharge device of FIG. 7 in the plane A-A of FIG. 7;

FIG. 9 shows a cross section through the discharge device of FIG. 7 in the plane B-B of FIG. 7;

FIG. 10 shows a perspective view of a discharge device with the multiple cartridge not fastened and the advancing element axially advanced;

FIG. 11 shows a central longitudinal section through the discharge device of FIG. 10;

FIG. 12 shows a cross section through the discharge device of FIG. 11 in the plane C-C of FIG. 11;

FIG. 13 shows a cross section through the discharge device of FIG. 11 in the plane D-D of FIG. 11.

### DESCRIPTION OF PREFERRED EMBODIMENTS

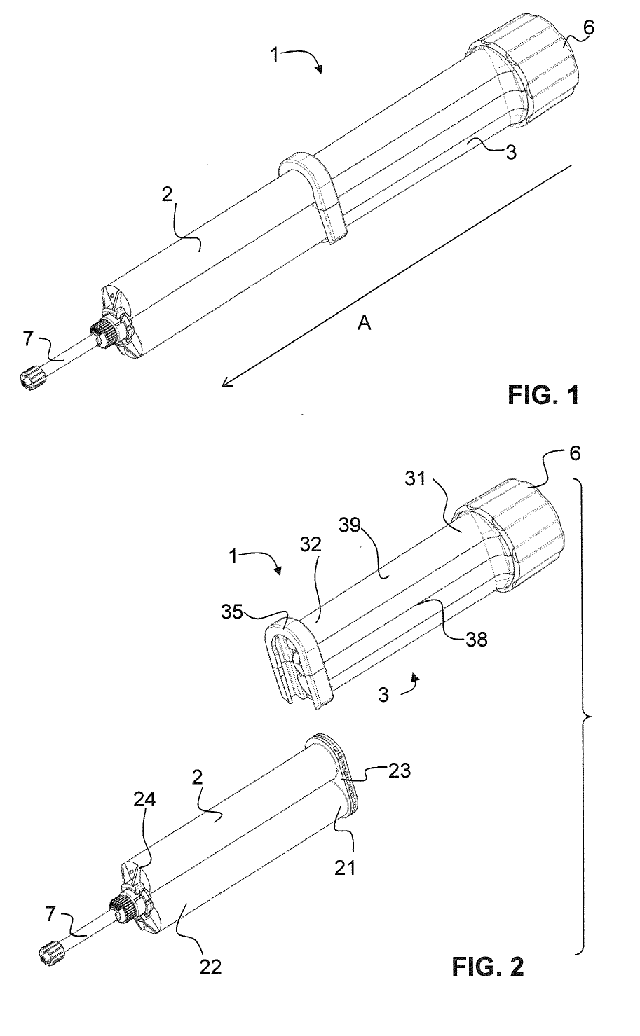

FIGS. 1 to 13 illustrate different views of a preferred embodiment of a discharge device 1 according to the invention. A double cartridge 2, which is provided with a mixing attachment 7, can be fastened to the discharge device.

A distal direction A is defined as the direction along which the pistons of the double cartridge move in order to discharge components from the double cartridge 2 into the mixing attachment 7. The opposite direction to this is designated as the proximal direction. Both the distal and the proximal direction can be designated as the axial direction. Any direction which runs transversely to the axial direction is designated as the lateral or sideways direction.

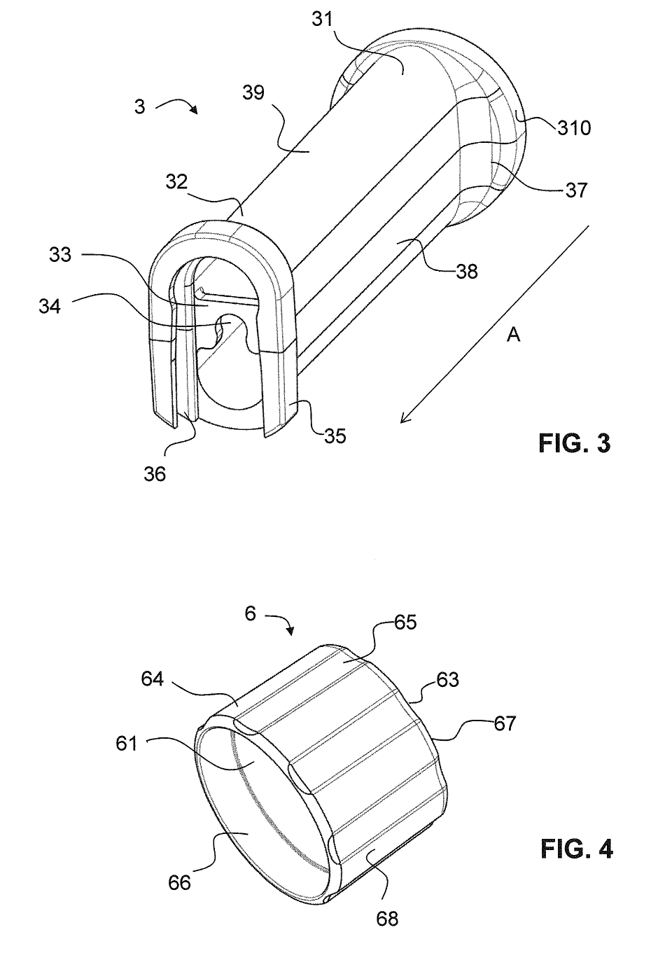

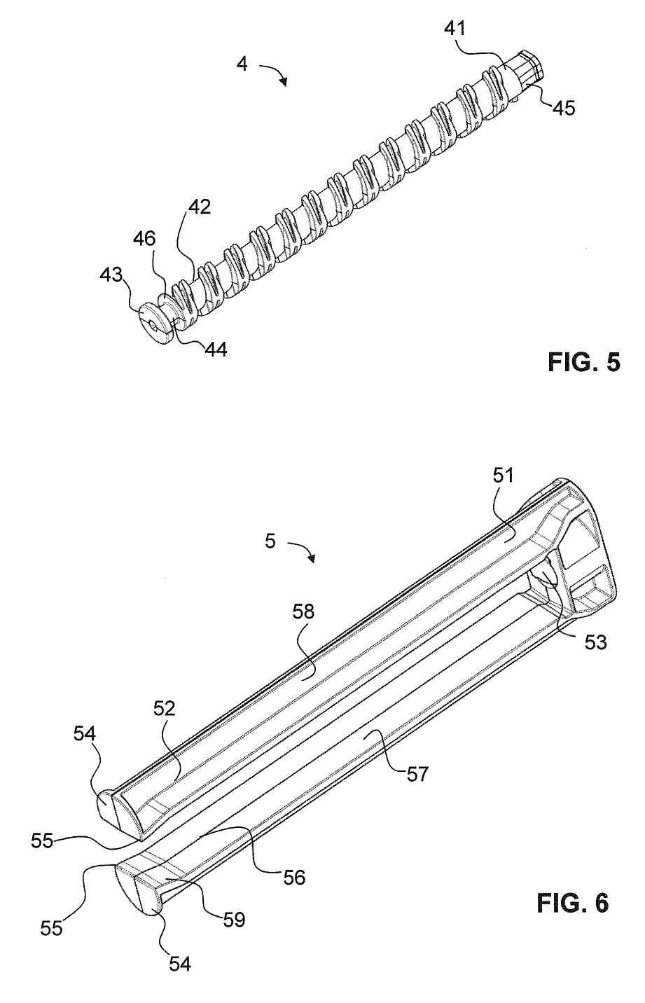

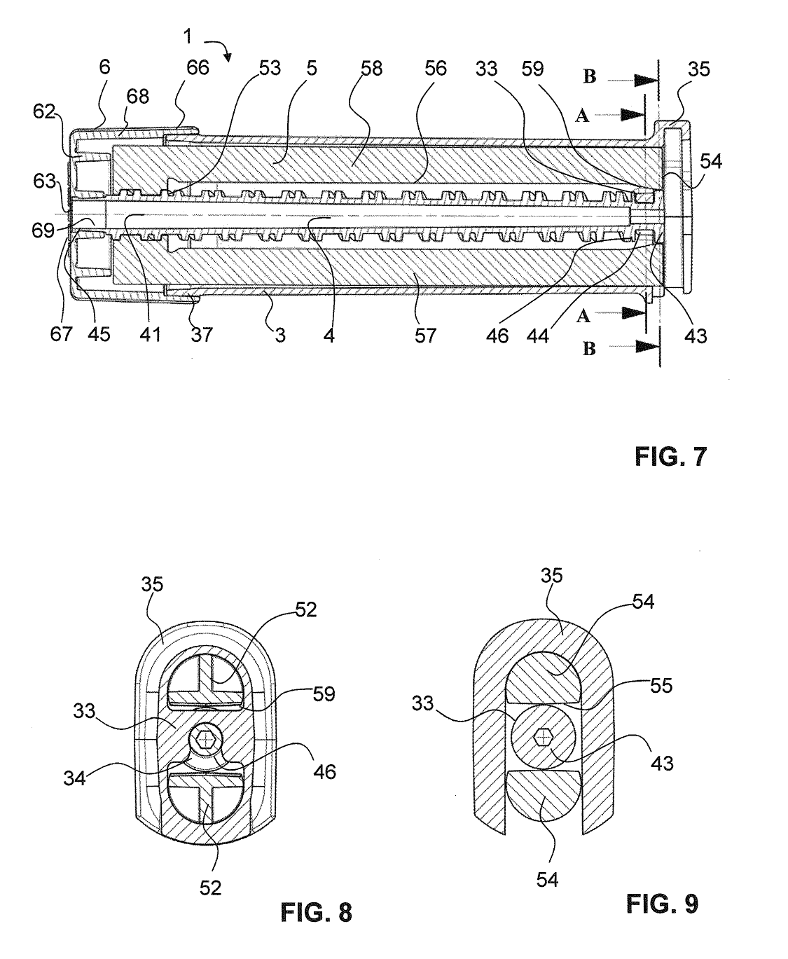

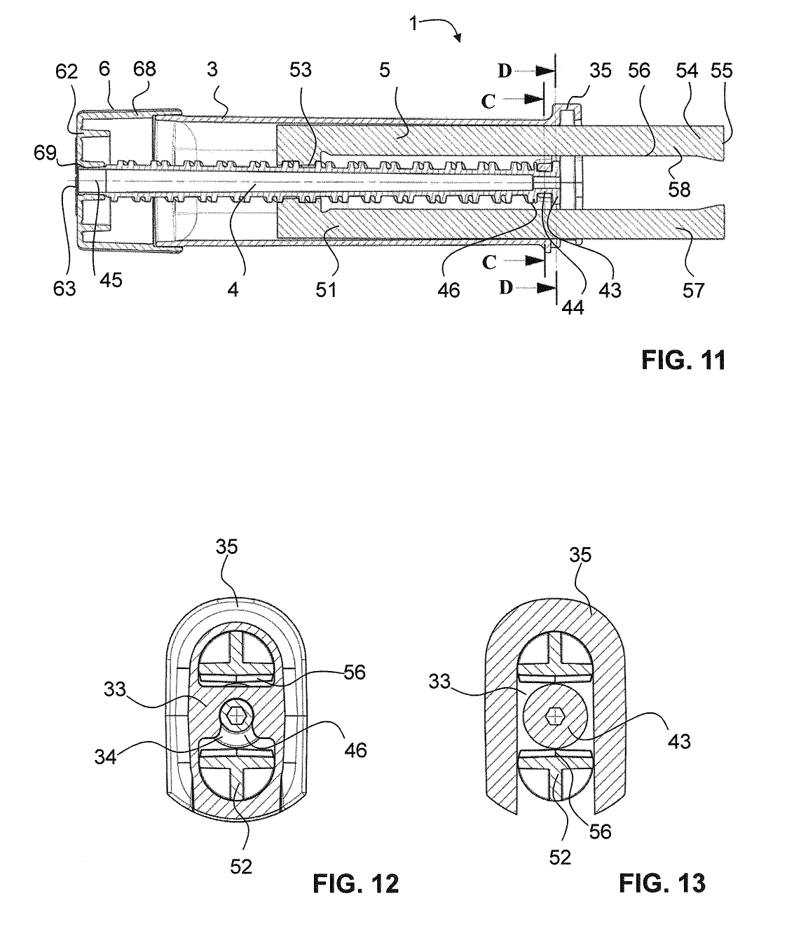

As can be seen in particular from FIGS. 7 and 11, the discharge device 1 comprises a housing 3, a threaded rod 4, an advancing element in the form of a double plunger 5 and a rotary member in the form of a rotary drum 6. The housing 3 is shown on its own in FIG. 3; the threaded rod is shown on its own in FIG. 5; the double plunger 5 is shown on its own in FIG. 6; and the rotary drum 6 is shown on its own in FIG. 4.

As will be explained in more detail below, the threaded rod 4 has an external thread and is arranged so as to be rotatable in the housing 3. The rotary drum 6 is also mounted so as to be rotatable on the housing 3 and is non-rotatably connected to the threaded rod 4. The double plunger 5 has an internal thread, is arranged so as to be non-rotatable in the housing 3 and engages in the external thread of the threaded rod 4. As a result of rotating the rotary drum 6, the threaded rod 4 is made to rotate. On account of the threaded engagement with the double plunger 5, the double plunger 5, as a result, is advanced axially in the distal direction A (see FIG. 1), as a result of which the components are discharged from the double cartridge 2.

As can be seen in particular from FIGS. 1 to 3, the housing 3 is designed in an elongated manner, comprises two oppositely situated, flattened side walls 38 and two oppositely situated, rounded connection regions 39 such that the housing 3 can be gripped well by a hand. The housing 3, in this case, has a preferred circumference of approximately 8-20 cm, a preferred length of approximately 10-30 cm, a preferred width of approximately 3-6 cm and a preferred height of approximately 1.5-3 cm. The height is to be understood, in this case, as the distance between the flattened side walls 38 and the width is to be understood as the distance between the rounded connection regions 39.

As can be seen particularly well in FIG. 3, the housing has a proximal end 31 and a distal end 32. A retaining element in the form of a bridge 33, which extends transversely relative to the distal direction A, along the entire height of the housing 3, through said housing, is formed in the interior of the housing 3 in the region of its distal end 32. The bridge 33 is consequently connected at its two ends to two oppositely situated housing regions (here to in each case one region of a side wall 38). It is web-shaped and in its center comprises a substantially U-shaped recess 34. Said recess 3 is open laterally toward one side.

To fasten the double cartridge 2 to the housing 3, a container receiving means 35 is formed on the distal end 32 of the housing 3. The container receiving means 35 is open at the side. It comprises a guide means in the form of a groove 36 which extends on the inside surface of the container receiving means 35 along its circumferential direction and which interacts with a guide means, which is formed on the proximal end 21 of the double cartridge 2, is complementary to the groove 36 and is in the form of a flange 23, in such a manner that the double cartridge 2 can be inserted sideways into the container receiving means 35 and retained on the housing 3.

At its proximal end 31, the housing 3 comprises a widened end region 37, on the outer lateral surface of which a guide surface 310 is formed for the rotary drum 6, which guide surface extends along the circumferential direction and tapers slightly in a conical manner in the proximal direction.

A perspective view of the rotary drum 6 is shown in FIG. 4. The rotary drum 5 comprises a covering wall 67 and a circumferential lateral surface wall 68. The circumferential lateral surface wall 68 comprises notches 65 along the axial direction on its outside surface 64, as a result of which it is possible to grip the rotary drum 6 well and control the rotation thereof.

On the inside surface 61, the lateral surface wall 68 comprises a counter surface 66 which extends along the circumferential direction and is designed in a complementary manner to the guide surface 310 of the housing 3. Said guide surface is consequently widened slightly conically in the distal direction. When the discharge device 1 is mounted, the rotary drum 6 is put over the widened proximal end region 37 of the housing with its distal open end, the conical form of the guide surface 310 and of the counter surface 66 facilitating said interlocking. As soon as said two surfaces rest one on top of the other, they form a self-centering rotary guide for the rotary drum 6 on the housing 3.

As can be seen in FIGS. 7 and 11, the covering wall 67 of the rotary drum 6 is provided with a central receiving opening 63 for the proximal end 41 of the threaded rod 4. A socket 69, which additionally receives the proximal end 41 of the threaded rod, is formed in addition in the region of said receiving opening 63. The socket 69 and the receiving opening have a non-rotationally symmetrical cross section (in particular a substantially square-shaped cross section).

In order to ensure good handling qualities, the rotary drum preferably comprises a circumference of approximately 8-20 cm. The length of the rotary drum is preferably at least approximately 3 cm such that it is able to be gripped well by the hand of a user.

As can be seen in FIG. 5, the threaded rod 4 has a proximal end 41 and a distal end 42. On the proximal end 41, a support region 45 is formed with a non-rotationally symmetrical cross section (in particular a substantially square-shaped cross section). The support region 45, in this case, is designed in such a manner that it can be received in a positive locking manner in the socket 69 and the receiving opening 63 of the rotary drum 6. As a result, a non-rotatable connection between the rotary drum 6 and the threaded rod 4 is ensured.

A tapering 44, to which a thickening in the form of a round end plate 43 is connected in the distal direction, is formed on the distal end 42 of the threaded rod 4. A stop ring 46 and, connected thereto, the distal end of the external thread, connects to the tapering in the proximal direction. The external thread is designed in a slotted manner in order to save material and to ensure good demoldability.

FIG. 6 shows a perspective representation of the double plunger 5. The double plunger 5 forms two piston rods 57 and 58. A threaded bush 53 is situated centrally on the proximal end 51 of the double plunger 5 and connects the two piston rods 57 and 58 together.

In the mounted state, the threaded rod 4 comes to rest between the two piston rods 57 and 58 of the double plunger 5. The length of the piston rods 57 and 58 corresponds approximately to the overall length of the double cartridge 2.

On their respective distal ends 52, the piston rods 57 and 58 comprise plunger faces 54 which press on pistons arranged in the double cartridge 2 when the components are discharged from the double cartridge 2 and, as a result, displace said pistons in the distal direction. In the present example, the plunger faces 54 are designed in a semicircular manner. An oblique surface 59, which is inclined in the axial direction and to which an inside surface 56 which extends in a proximal manner parallel to the axial direction is connected, is formed on the inside surface, directed toward the threaded rod 4, of the respective piston rod 57, 58 connecting directly to the straight delimiting edge 55 of the respective plunger face 54.

FIG. 7 shows a central longitudinal section through the discharge device 1 in an initial state. The tapering 44 on the distal end of the threaded rod 4 is received in the recess 34 of the bridge 33 of the housing 3. The proximal end 41 of the threaded rod 4 is received in the threaded bush 53 of the double plunger 5. As the rotary drum 6 has not yet been rotated, the double plunger 5 would not yet have been advanced in the axial direction through the discharge device 1. Stop structures 62, which extend in the distal direction into the rotary drum 6 and form stop surfaces which delimit a proximal movement of the double plunger 5 relative to the housing 3, are formed on its inside surface 61, on the side pointing toward the proximal housing end, on the covering wall of the rotary drum 6. In said embodiment, the stop structures 62 comprise the form of circular segments which extend from the proximal end of the discharge device 1 along the axial direction into the rotary drum 6.

FIG. 8 shows a cross section through the discharge device according to FIG. 7 in the plane A-A of FIG. 7. FIG. 9 shows a cross section though the discharge device according to FIG. 7 in the plane B-B of FIG. 7. The distal end of the threaded rod was inserted laterally into the recess 34 of the bridge 33 by way of its tapering 44 and is now received in said recess 34.

The end plate 43 of the threaded rod 4 is situated distally to the bridge 33, and the stop ring 46 of the threaded rod 4 is arranged proximally to the bridge 33. The end plate 43 and the stop ring 46 each comprise lateral dimensions which are greater than the clearance of the recess 34. This prevents the threaded rod 4 from being advanced in the distal direction and from being able to be pulled back in the proximal direction. All in all, therefore, the threaded rod 4 is fixed axially in relation to the housing 3 both in the distal and the proximal direction by the bridge 33. When viewed in the distal direction, the opaque surfaces 59 extend so far inward in the direction of the threaded rod 4 that they directly adjoin the end plate 43 laterally in the region of the end plate 43 (see FIGS. 7 and 9). As a result, in the initial state, the opaque surfaces fix the distal end of the threaded rod 4 in the lateral direction without, in this case, resting with too large a surface on the threaded rod. In this way, the distal end of the threaded rod 4, in the initial state in FIGS. 7-9, is laterally fixed in an almost play-free manner without the friction forces generated being too great when the discharge device 1 is actuated for the first time. In particular, in this way, the double plunger 5 prevents the threaded rod from being able to slide sideways out of the recess 34.

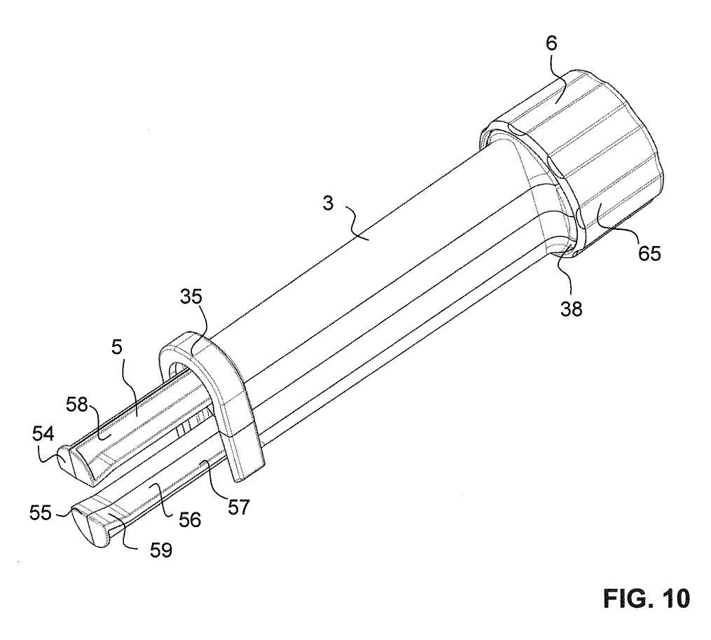

FIG. 10 shows a perspective view of the discharge device 1 and FIG. 11 shows a central longitudinal section through the discharge device 1 of FIG. 10 in an advanced state. The rotary drum 6 has now been rotated and the double plunger 5 has been advanced in the axial direction through the discharge device 1. As a result of the rotary drum 6 rotating, the threaded rod 4 has rotated inside the recess 34 of the bridge 33 and pushed the double plunger 5 forward in the axial direction on account of the threaded engagement between the threaded bush 53 and the threaded elements of the threaded rod 4. At the same time, the proximal end 51 of the double plunger 5 has moved away from the rotary drum 6 and its stop structures 62. The threaded rod 4 is still fixed in the axial direction by the tapering 44 that is received in the recess 34 of the bridge 33.

FIG. 12 shows a cross section through the discharge device according to FIG. 11 in the plane C-C of FIG. 11. FIG. 13 shows a cross section through the discharge device according to FIG. 11 in the plane D-D of FIG. 11. The inside surfaces 56 of the double plunger 5 are now situated laterally close to the end plate 43 of the threaded rod 4, but no longer directly adjoin the end plate 43. The distal end of the threaded rod 4, as a result, certainly has obtained some lateral play, but is still prevented by the double plunger from leaving the recess 34. When the rotary drum 6 is rotated, the threaded rod 4 is rotated, consequently fixed overall axially and laterally inside the recess 34, and the double plunger 5 is moved forward precisely in the distal direction on account of the threaded engagement between its threaded bush 53 and the threaded elements of the threaded rod 4.

If a double cartridge 2 is connected to the discharge device 1, in the advanced state of FIGS. 11-13, the double plunger 5 projects into the same and presses in such a manner onto the pistons arranged in the double cartridge 2 that said pistons are advanced in the distal direction and the components of the double cartridge 2 are discharged. An end state is reached when the double plunger 5 is advanced so far in the axial direction that its proximal end 51 reaches the distal end 32 of the housing.

Instead of a double cartridge, two separate syringes can also be used. The container receiving means 35 can be designed in a corresponding manner for receiving two syringes. It is also easily possible to modify the device such that three or more components can be discharged from a multiple cartridge with three or more reservoirs. To this end, the discharge element 5 can be designed as a multiple plunger, in particular as a triple plunger, where at least one further piston rod, which is also connected at its proximal end to the threaded bush 53, extends parallel to the two pistons 57 and 58. The housing 3, and in particular also the container receiving means 35, can easily be modified in a corresponding manner.

It is also easily possible to modify the manner in which the double or multiple cartridge or the syringes are fixed on the housing. Thus, for example, it is conceivable not to insert the cartridge or syringes sideways, but to plug them in axially and fix them, for example, by means of latching lugs or by means of a bayonet closure. In principle, it is also possible to realize the cartridge or the syringes as a non-detachable unit with the housing, in particular when the dispenser is only intended for single use.

The fixing of the threaded rod 4 in the housing 3 can also be effected by means of a retaining element which is developed in a manner other than as the bridge 33. Whilst it is advantageous for the retaining element to form a bridge between two oppositely situated housing regions, the retaining element can also be connected to the housing on only one side.

The form and the dimension of the recess 34 can be chosen such that the threaded rod 4 with its tapering 44 can only be inserted (clicked) into the recess 34 by overcoming a certain minimum force and correspondingly can also only be removed again from the recess by overcoming a minimum force. In this way, the threaded rod 4 can be prevented from slipping sideways out of the retaining element during assembly before the threaded rod 4 is secured against falling out by the double plunger 5.

The axial displacement of the double plunger 5 can also be effected according to a different rotary drive instead of by means of a rotary drum 6. Thus, it is conceivable, for example, to mount a rotary handle onto the housing 3, which rotary handle interacts with the threaded rod 4 such that said threaded rod also rotates when the rotary handle is rotated.

### LIST OF REFERENCE SIGNS

1 Discharge device
2 Multiple cartridge
21 Proximal end
22 Distal end
23 Flange
24 Discharge opening
3 Housing
31 Proximal end
32 Distal end
33 Bridge
34 Recess
35 Container receiving means
36 Groove
37 Widened end region
38 Side wall
39 Connecting region
310 Guide surface
4 Threaded rod
41 Proximal end
42 Distal end
43 End plate
44 Tapering
45 Support region
46 Stop ring
5 Double plunger
51 Proximal end
52 Distal end
53 Threaded bush
54 Plunger face
55 Delimiting edge
56 Inside surface
57,58 Piston rod
59 Oblique surface
6 Rotary drum
61 Inside surface
62 Stop structure
63 Receiving opening
64 Outside surface
65 Notch
66 Counter surface
67 Covering wall
68 Lateral surface wall
69 Socket
7 Mixing attachment

1. A discharge device for a multiple cartridge or for at least two syringes in order to discharge at least two components from the multiple cartridge or from the syringes, said discharge device comprising:
a housing with a proximal end and a distal end;
a threaded rod with a proximal end and a distal end, wherein the threaded rod has an external thread and is arranged so as to be rotatable in the housing; and
an advancing element with a proximal end and a distal end, wherein the advancing element has an internal thread and is arranged so as to be axially displaceable and non-rotatable in the housing;
wherein the external thread of the threaded rod engages in such a manner in the internal thread of the advancing element that as a result of a rotation of the threaded rod relative to the housing, the advancing element is advanceable in a distal direction, and
wherein the threaded rod comprises a tapering in the region of its distal end,
wherein a retaining element is formed on the housing in the region of its distal end, wherein the retaining element comprises a laterally open recess, and wherein the threaded rod is inserted in such a manner laterally by way of its tapering into the recess of the retaining element that the retaining element fixes the threaded rod axially in the housing both with reference to the distal direction and with reference to a proximal direction that is opposite thereto.

2. The discharge device as claimed in claim 1, wherein the advancing element forms a double plunger with two piston rods which are arranged in parallel and are connected proximally by means of a threaded bush, wherein the internal thread is formed in the threaded bush, and wherein the piston rods extend on both sides of the threaded rod in the distal direction such that one of the piston rods prevents the threaded rod from moving out of the recess of the retaining element.

3. The discharge device as claimed in claim 1, wherein the retaining element is designed as a bridge which extends between two oppositely situated regions of the housing.

4. The discharge device as claimed in claim 1, wherein a thickening is formed on the distal end of the threaded rod in a region located distally from the tapering, wherein the thickening is arranged distally to the retaining element, and wherein the thickening comprises a greater diameter than the recess.

5. The discharge device as claimed in claim 4, wherein the thickening is designed as an end plate.

6. The discharge device as claimed in claim 1, which discharge device additionally comprises a rotary member which is arranged on the proximal end of the housing so as to be rotatable and is connected non-rotatably to the proximal end of the threaded rod.

7. The discharge device as claimed in claim 6, wherein the rotary member comprises at least one stop surface, which delimits a proximal movement of the advancing element relative to the housing, on an inside surface which is situated opposite the proximal end of the housing.

8. The discharge device as claimed in claim 6, wherein the rotary member is designed in a drum-like manner with a lateral surface wall, wherein the proximal end of the housing comprises a guide surface which tapers in the manner of a cone in the proximal direction, and wherein on the inside of its lateral surface wall, the rotary member comprises a conical counter surface which is complementary to the guide surface.

9. The discharge device as claimed in claim 1, wherein at least one container receiving means for fastening the multiple cartridge or the syringes on the housing is formed on the distal end of the housing.

10. The discharge device as claimed in claim 9, wherein the container receiving means is designed in such a manner that the multiple cartridge or the syringes are insertable laterally into the container receiving means.

11. The discharge device as claimed in claim 1, which discharge device additionally comprises a multiple cartridge or at least two syringes, wherein the multiple cartridge or the syringes form at least two outlets, wherein the advancing element is insertable into the multiple cartridge or into the syringes in order to discharge at least two components through the outlets out of the multiple cartridge or the syringes, and wherein the discharge device additionally comprises a mixing attachment which is mounted above the outlets in order to mix the components which emerge from the outlets.
